(19) United States
(12) Patent Application Publication
(10) Pub. No.: US 2020/0228025 A1
(43) Pub. Date: Jul. 16, 2020

(54) Systems and Methods for Low Voltage Power Distribution

(71) Applicant: Fluence Bioengineering, Inc., Austin, TX (US)

(72) Inventor: Paul Morgenstern, Austin, TX (US)

(73) Assignee: Fluence Bioengineering, Inc., Austin, TX (US)

(21) Appl. No.: 16/740,869

(22) Filed: Jan. 13, 2020

Related U.S. Application Data
(60) Provisional application No. 62/792,235, filed on Jan. 14, 2019.

(51) Int. Cl. H02M 7/06; H02M 5/14; H02J 3/14

(52) U.S. Cl. CPC H02M 7/06; H02J 3/14; H02M 5/14

(57) ABSTRACT

Implementations disclosed herein are directed towards low voltage electrical distribution systems. The systems may include an alternating current (AC) power source configured to generate a three-phase AC power signal, a three-conductor cable coupled to the AC power source, at least one rectifier coupled to the three-conductor cable, in which the at least one rectifier is configured to convert the three-phase AC power signal to a DC power signal, and at least one electrical load coupled to the at least one rectifier.

### CROSS-REFERENCE TO RELATED APPLICATIONS

This application claims a benefit of priority under 35 U.S.C. § 119 to U.S. Provisional Application No. 62/792,235, entitled “Systems and Methods for Low Voltage Power Distribution,” filed on Jan. 14, 2019, which is fully incorporated herein by reference in their entirety.

### BACKGROUND INFORMATION

### Field of the Disclosure

Examples of the present disclosure are related to systems and methods for low voltage power distribution. More particularly, implementations are related with low voltage, three-phase power distribution systems for light emitting diodes (LEDs), which convert alternating current (AC) power to direct current (DC) power at a position proximate to a LED load.

### Background

Controlled environment agriculture is becoming more prevalent in the US and around the world. Conventional controlled environment agriculture relies on light fixtures to illuminate a plant canopy. The light fixtures, such as LED light fixtures, distribute radiant flux over the plant canopy to increase production yields, control harvest cycles, etc.

Conventionally, to power LED light fixtures, DC conduits, wires, electrical boxes, etc. transmit power from a transformer to an outlet. The LED light fixture is then plugged into the outlet to receive DC power. When dealing with controlled environment agriculture, the cost of installation of hundreds of LED light fixtures are significant. Furthermore, these costs associated with installation and hardware for DC systems may be higher than those associated with low voltage, three-phase AC electrical distribution systems.

As such, a three-wire three-phase circuit is typically more economical than an equivalent two-wire single-phase circuit because it uses less conductor material to transmit a given amount of electrical power. Additionally, low voltage systems may not require as strict governmental rules and regulations.

Accordingly, needs exist for more effective and efficient systems and methods for low power distribution using a three-conductor cable, wherein insulation displacement connectors will distribute the low voltage three-phase AC to LED light fixtures.

### SUMMARY

Implementations disclosed herein are directed towards low voltage three phase AC electrical distribution systems. Implementations may include a three-phase transformer, conductor cables, insulation displacement connectors (IDCs), rectifier, and LED loads. The systems may enable AC power to be converted to DC power at a position more proximate to the LED load.

The three-phase transformer may be configured to step voltages up or down. The three-phase transformer may include three sets of primary and secondary windings, wherein each set of windings is wound around a separate leg of a core assembly. The sets of primary and secondary windings may be connected in a delta or “Y” configuration to form a complete unit. In some implementations, the three-phase transformer may be configured to supply power to a three-conductor cable.

The conductor cables may be configured to transfer the AC from the transformer to a rectifier. In implementations, three conductor cables may be utilized, such that each of the conductor cables carries a single phase of the AC current.

The IDCs may be electrical connectors configured to facilitate an electrical connection between the conductor cables and the rectifier. A first end of the insulation displacement connectors may be configured to pierce the insulation on a conductor cable, and a second end of the insulation displacement connector may be coupled to the rectifier. By utilizing insulation displacement connectors between the conductor cable and the rectifier, installation costs may be reduced due to the reduction in the stripping, twisting, and mounting processes that are typically required when using an outlet for DC circuits.

The rectifier may be an electrical device that is configured to convert AC to DC. A first end of the rectifier may be coupled to ends of the insulation displacement connectors, and a second end of the rectifier may be coupled to the LED load. Responsive to receiving the AC from the insulation displacement connectors, the rectifier may convert the AC to DC, and transmit the DC to the LED load.

The LED load may be an amount of electrical power required to power a set of LEDs and associated electronics. In implementations, the LED load may be a low voltage circuit, which may be exempt from certain regulatory protections required at higher voltages.

These, and other, aspects of the disclosure will be better appreciated and understood when considered in conjunction with the following description and the accompanying drawings. The following description, while indicating various implementations and numerous specific details thereof, is given by way of illustration and not of limitation. Many substitutions, modifications, additions or rearrangements may be made within the scope of the disclosure, and the disclosure includes all such substitutions, modifications, additions or rearrangements.

### BRIEF DESCRIPTION OF THE DRAWINGS

Non-limiting and non-exhaustive implementations of the present implementations are described with reference to the following figures, wherein like reference numerals refer to like parts throughout the various views unless otherwise specified.

FIG. 1 is a block diagram of an AC electrical distribution system according to various implementations.

FIG. 2 is a block diagram of an electrical conversion point for an electrical distribution system according to various implementations.

FIG. 3 is a block diagram of another AC electrical distribution system according to various implementations.

FIG. 4 is a block diagram of an electrical connection point for an electrical distribution system according to various implementations.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help improve understanding of various implementations of the present disclosure. Also, common but well-understood elements that are useful or necessary in a commercially feasible implementation are often not depicted in order to facilitate a less obstructed view of these various implementations of the present disclosure.

### DETAILED DESCRIPTION

In the following description, numerous specific details are set forth in order to provide a thorough understanding of the present implementations. It will be apparent, however, to one having ordinary skill in the art that the specific detail need not be employed to practice the present implementations. In other instances, well-known materials or methods have not been described in detail in order to avoid obscuring the present implementations.

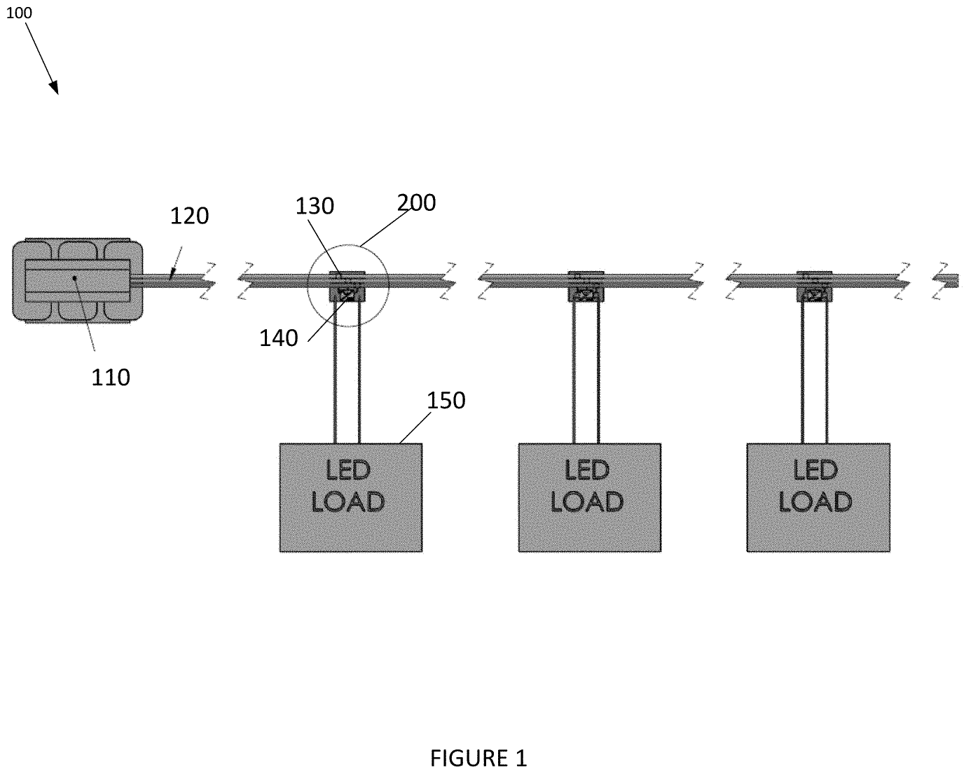

FIG. 1 depicts an AC electrical distribution system 100, according to various implementations. System 100 may be configured to provide low voltage three-phase AC to a plurality of LED light fixtures. Furthermore, system 100 may be configured to transmit AC to a location that is proximate to the LED light fixtures. At the proximate location, the AC may be converted to DC. This may reduce costs associated with transmitting DC power over large distances. System 100 may include a transformer 110, a three-conductor cable 120, insulation displacement connectors 130, rectifier 140, and LED loads 150.

Transformer 110 may be a three-phase transformer that is configured to step up or down voltages. Transformer 110 may include three sets of primary and secondary windings, wherein each set of windings is wound around a separate leg of a core assembly. The sets of primary and secondary windings may be connected in a delta or “Y” configuration to form a complete unit. In implementations, transformer 110 may be configured to supply AC to three-conductor cable 120.

Three-conductor cable 120 may be configured to transfer the AC from transformer 120 to rectifier 140. Each cable of the three-conductor cables 120 may be coupled to a different set of windings associated with transformer 110. Thus, each of the conductor cables 120 may carry a single phase of the AC current.

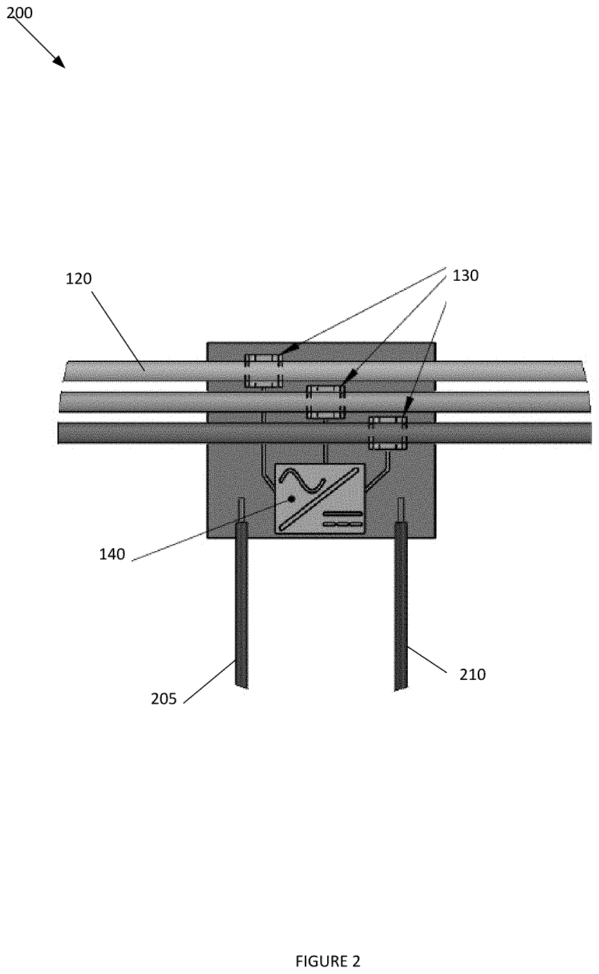

Insulation displacement connectors 130 may be water-tight electrical connectors configured to facilitate an electrical connection between the three-conductor cable 120 and the rectifier 140 at electrical conversion point 200, which is described in further detail with reference to FIG. 2. A first end of insulation displacement connectors 130 may be configured to pierce the insulation on a conductor cable 120, and a second end of the insulation displacement connector 130 may be coupled to the rectifier 140. By utilizing insulation displacement connectors 130 between the three conductor cables 120 and the rectifier 140, installation costs may be reduced due to the reduction in the stripping, twisting, and mounting processes that are typically required when using an outlet for DC circuits. In some implementations, insulation displacement connectors 130 may be configured to embed and/or extract a digital signal into a three phase AC power distribution bus.

Rectifier 140 may be an electrical device that is configured to convert AC to DC. A first end of rectifier 140 may be coupled to ends of the insulation displacement connectors 130, and a second end of rectifier 140 may be coupled to LED load 150. Responsive to receiving the AC from the insulation displacement connectors 130, rectifier 140 may convert the AC to DC, and transmit the DC to LED load 150.

LED load 150 may be an amount of electrical power required to power a set of LEDs and associated electronics. In implementations, LED load 150 may be a low voltage circuit, which may be exempt from regulatory protections required at higher voltages.

FIG. 2 depicts electrical conversion point 200 according to various implementations. Some elements depicted in FIG. 2 may have been previously described, and for the sake of brevity a further description of these elements may be omitted.

As depicted in FIG. 2, the insulation displacement connector 130 includes three independent displacement points, each of which may be coupled to a different conductor cable of the three-conductor cable 120. Further, rectifier 140 may be configured to receive the AC from the insulation displacement connectors 130, and transmit DC through a power supply line 205 and ground 210. By positioning electrical conversion point 200 closer to the LED load 150, costs associated with DC wiring may be drastically reduced.

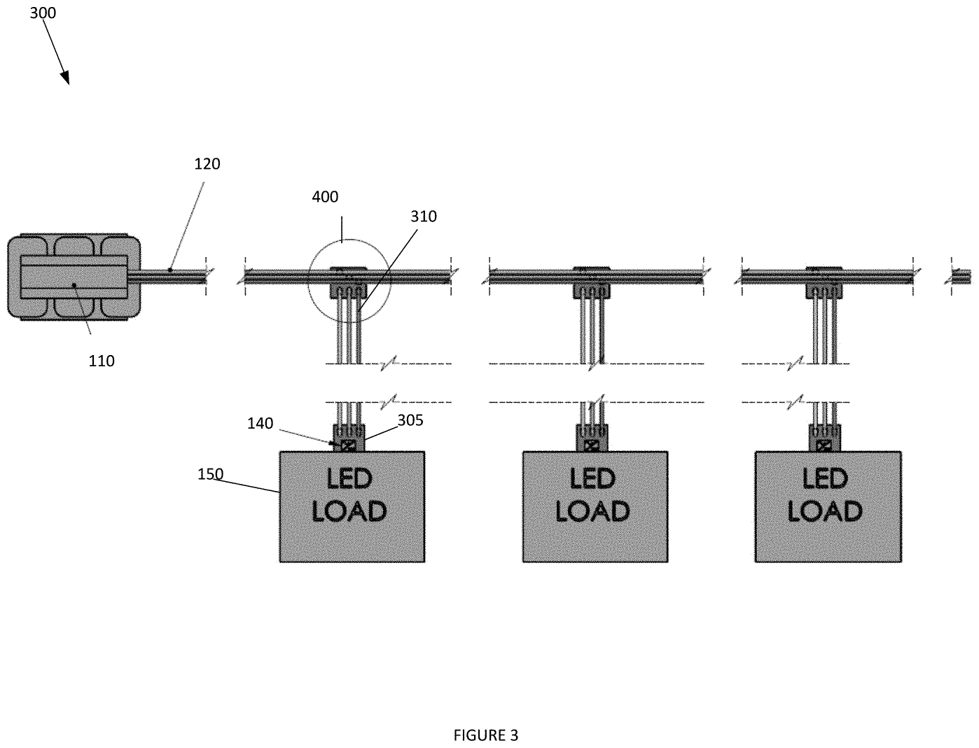

FIG. 3 depicts an AC electrical distribution system 300, according to various implementations. Some elements depicted in FIG. 3 may have been previously described, and for the sake of brevity a further description of these elements may be omitted.

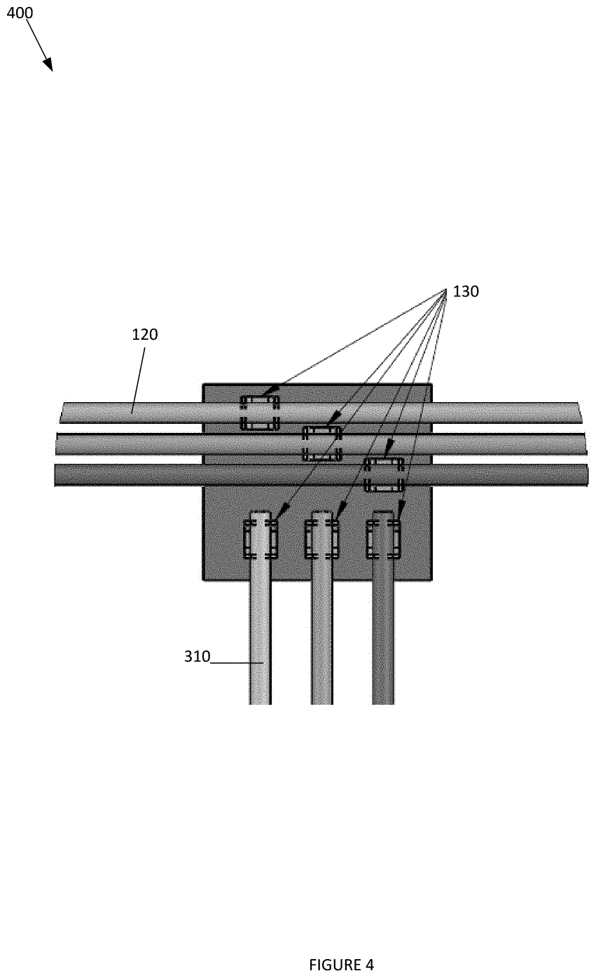

As depicted in FIG. 3, an electrical circuit 305 with a rectifier 140 may be directly positioned at the LED load 150. This may enable AC to be transmitted from transformer 110 to a first set of three-conductor cables 120, then to a second set of three-conductor cables 310, and to circuit 305 at LED load 150. Locating the AC to DC conversion point at the LED load 150 may further reduce material and installation costs. The first set of three-conductor cables 120 are coupled to the second set of three-conductor cables 310 at electrical connection point 310, which is described in further detail with respect to FIG. 4.

FIG. 4 depicts electrical connection point 400, according to various implementations. Some elements depicted in FIG. 4 may have been described previously, and for the sake of brevity a further description of these elements may be omitted.

As depicted in FIG. 4, electrical connection point 310 may utilize two sets of conductor's cables 120, 310 to transport AC to a location proximate to LED load 150. In some implementations, each conductor cable in the first set of three-conductor cables 120 may have a corresponding pair within the second set of three-conductor cables 310, which are linked via insulation displacement connectors 130.

Although the present technology has been described in detail for the purpose of illustration based on what is currently considered to be the most practical and preferred implementations, it is to be understood that such detail is solely for that purpose and that the technology is not limited to the disclosed implementations, but, on the contrary, is intended to cover modifications and equivalent arrangements that are within the spirit and scope of the appended claims. For example, it is to be understood that the present technology contemplates that, to the extent possible, one or more features of any implementation can be combined with one or more features of any other implementation.

Reference throughout this specification to “one implementation”, “an implementation”, “one example” or “an example” means that a particular feature, structure or characteristic described in connection with the implementation or example is included in at least one implementation of the present disclosure. Thus, appearances of the phrases “in one implementation”, “in an implementation”, “one example” or “an example” in various places throughout this specification are not necessarily all referring to the same implementation or example. Furthermore, the particular features, structures or characteristics may be combined in any suitable combinations and/or sub-combinations in one or more implementations or examples. In addition, it is appreciated that the figures provided herewith are for explanation purposes to persons ordinarily skilled in the art and that the drawings are not necessarily drawn to scale.

The flowcharts and block diagrams in the flow diagrams illustrate the architecture, functionality, and operation of possible implementations of systems, methods, and computer program products according to various implementations of the present disclosure. In this regard, each block in the flowcharts or block diagrams may represent a module, segment, or portion of code, which comprises one or more executable instructions for implementing the specified logical function(s). It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

We claim:

1. An electrical distribution system, comprising:
an alternating current (AC) power source configured to generate a three-phase AC power signal;
a three-conductor cable coupled to the AC power source;
at least one rectifier coupled to the three-conductor cable, wherein the at least one rectifier is configured to convert the three-phase AC power signal to a DC power signal; and
at least one electrical load coupled to the at least one rectifier.

2. The system of claim 1, wherein the AC power source comprises a transformer having three pairs of primary and secondary windings, wherein each pair is wound around a separate leg of a core assembly.

3. The system of claim 2, wherein each cable in the three-conductor cable is connected to a different secondary winding of the three pairs of primary and secondary windings.

4. The system of claim 1, wherein the at least one electrical load comprises a light emitting diode (LED) load.

5. The system of claim 4, wherein the LED load comprises a low voltage circuit configured to illuminate plants.

6. The system of claim 1, wherein the three-conductor cable is coupled to the at least one rectifier via insulation displace connectors.

7. The system of claim 1, wherein the three-conductor cable is coupled to the at least one rectifier via a second three-conductor cable.

8. The system of claim 7, wherein the three-conductor cable is coupled to the second three-conductor cable via insulation displace connectors.

9. The system of claim 1, wherein the at least one rectifier is located proximate to the at least one electrical load.

10. The system of claim 9, wherein the at least one rectifier is located at the at least one electrical load.

11. A method of distributing power, comprising:
generating a three-phase alternating current (AC) power signal;
transmitting the three-phase AC power signal to at least one rectifier via a three-conductor cable;
converting, by the least one rectifier, the AC power signal to a DC power signal; and
providing the DC power signal to one or more electrical loads.

12. The method of claim 11, wherein the three-phase AC power signal is generated by a transformer having three pairs of primary and secondary windings, wherein each pair is wound around a separate leg of a core assembly.

13. The method of claim 12, wherein each cable in the three-conductor cable is connected to a different secondary winding of the three pairs of primary and secondary windings.

14. The method of claim 11, wherein the at least one electrical load comprises a light emitting diode (LED) load.

15. The method of claim 14, wherein the LED load comprises a low voltage circuit configured to illuminate plants.

16. The method of claim 1, wherein the three-conductor cable is coupled to the at least one rectifier via insulation displace connectors.

17. The method of claim 11, wherein the three-conductor cable is coupled to the at least one rectifier via a second three-conductor cable.

18. The method of claim 17, wherein the three-conductor cable is coupled to the second three-conductor cable via insulation displace connectors.

19. The method of claim 11, wherein the at least one rectifier is located proximate to the at least one electrical load.

20. The method of claim 19, wherein the at least one rectifier is located at the at least one electrical load.
